(19) United States
(12) Patent Application Publication
(10) Pub. No.: US 2018/0186475 A1
(43) Pub. Date: Jul. 5, 2018

(54) SYSTEM AND METHOD FOR REFURBISHING AIRCRAFT STRUCTURES

(71) Applicant: COC Aerospace, Camarillo, CA (US)

(72) Inventor: Christopher Garville, Camarillo, CA (US)

(21) Appl. No.: 15/847,834

(22) Filed: Dec. 19, 2017

Related U.S. Application Data
(60) Provisional application No. 62/436,386, filed on Dec. 19, 2016.

(51) Int. Cl. B64F 5/40; B64F 5/60

(52) U.S. Cl. CPC B64F 5/40; H04N 13/0488; H04N 2213/001; B64F 5/60; H04N 13/0275

(57) ABSTRACT

A system and method for refurbishing structures is provided. The system includes a structure assembly comprising a holding fixture and a structure needing to be repair, an imaging device, and an image projection apparatus, where the imaging device and the image projection apparatus are electrically coupled to a central processing unit. The imaging device may include one or more digital cameras positioned at various locations about the structure assembly to capture images of the structure along various lines of sight. The captured image are transmitted to the CPU and stored as data and a three-dimensional (3D) surface model of the structure is generated by a 3D computer-aided design (CAD) software system executed by the CPU. The image projection apparatus may include one or more image projectors (e.g., video projectors) positioned at various locations about the structure assembly that project instructions about how to disassemble and re-assemble the structure onto the outer surface of the structure.

### CROSS-REFERENCE TO RELATED APPLICATION

The present application claims benefit of priority with U.S. Provisional Application No. 62/436,386, filed on Dec. 19, 2016, entitled “SYSTEM AND METHOD FOR REFURBISHING AIRCRAFT STRUCTURES,” the disclosure of which is incorporated in its entirety by reference in this application.

### TECHNICAL FIELD

The present disclosure generally relates to structure repair, and more particularly, to a system and method for refurbishing structures.

### BACKGROUND

Costs to replace aging structures with newly constructed structures can be prohibitive, especially for structures that are complex or must meet certain industry standards. For example, costs to replace aging aircraft with newly constructed aircraft having modern avionics are staggering. The costs to acquire new aircraft include the costs of purchasing maintenance equipment, training, spares and facilities. For certain third world countries and companies, and countries and companies with limited budgets, the costs to purchase new aircraft are well beyond their financial means. For these countries and companies, their only alternative is to purchase aging aircraft and repair, reconstruct and/or restore these aircraft according to their original specifications. Such aircraft may also be retrofit with modern avionic systems and technology. However, the maintenance required to maintain these aircraft in an airworthy condition can also be extremely costly and time consuming.

An additional challenge faced by these countries and companies that utilize restored aircraft is the limited skill level of the technicians servicing these aircraft. For example, these countries typically use technicians who are on active duty and have limited experience servicing these types of military aircraft. Countries with well-funded military, such as the United States, typically utilize technicians with decades of experience, many of whom are military personnel who have retired from active duty. The limited experience of these technicians present significant challenges, as the repair and reconstruction of certain aircraft structures require the use of technicians with certain specialized skills. Plus, an inexperienced technician may not know how to properly disassemble and reassemble certain aircraft components and may damage the components if the technician is careless in servicing the component.

A need therefore exists to develop highly cost effective and fast cycle time repairs and reconstructions of aging structures, such as aircraft.

### SUMMARY

A system and method for refurbishing structures is provided. The system may include a structure assembly comprising a holding fixture and a structure needing to be repair, an imaging device, and an image projection apparatus, where the imaging device and the image projection apparatus are electrically coupled to a central processing unit (CPU). The imaging device may include one or more digital cameras positioned at various locations about the structure assembly to capture images of the structure along various lines of sight. The captured image data is then transmitted to the CPU where the data is stored and a three-dimensional (3D) surface model of the structure is generated by a 3D computer-aided design (CAD) software system executed by the CPU.

The image projection apparatus may include one or more image projectors (e.g., video projectors) positioned at various locations about the structure assembly that project instructions about how to disassemble and re-assemble the structure onto the outer surface of the structure. In this way, the image projection apparatus not only show a user which fasteners of the structure must be removed, but also instructs the user when, where and how to remove the fasteners. Thus, enabling the user to quickly disassemble, repair, and reassemble the structure.

The method generally includes constructing a holding fixture for securing a structure needing repair. A first set of photogrammetric targets may be affixed to the fixture at certain locations. The fixture may then be scanned by digital (photogrammetric) cameras. The digital cameras transmit data to a CPU which imports the data into a 3D CAD software system, operated by the CPU, that generates a three-dimensional surface model representing the external surfaces of the fixture and a simulated two-dimensional geographical reference plane extending through the center of the holding fixture.

A structure needing repair may then be installed into the holding fixture. The holding fixture secures the entire structure, including the substructures and parts of the main structure, in an upstanding fashion. A second set of photogrammetric targets may be affixed to one or more outer surfaces of the structure at certain locations about the structure. For purposed of the present disclosure, an outer surface of the structure or sheets of material covering the structure may be referred to herein as the “structure skin” or simply “the skin.”

The structure may then be scanned by the digital cameras to dimensionally locate (via photogrammetry) the structure relative to the first set of photogrammetric targets and the reference plane. The data collected by this digital imaging technique is imported into the 3D CAD system, which generates a three-dimensional surface model representing the external surfaces of the structure.

In certain embodiments, during the scanning process, the digital cameras may detect the dimensions of the structure and the location of the fastener holes machined into the structure skin. Those dimensions may be stored in the 3D CAD software database.

In certain embodiments, once the structure is secured in the fixture and dimensionally located, a preliminary inspection by non-destructive inspection or non-destructive testing (NDT/NDI inspection) may be performed, primarily with radiography and ultrasonic equipment, to detect defects (damage, corrosion, fatigue/stress cracking), if any, in the structure.

In certain embodiments, the structure may be disassembled. During disassembly, an electrical discharge machine (EDM) or “EDrill” may be used to sever the heads of the fasteners securing the structure. During disassembly, image projection equipment coupled to the CPU and CAD software may project information relating to each fastener or fastener type onto a structure working surface (i.e., a skin) to assist the user in locating the bolt heads to be removed from the structure. In these embodiments, the image projection apparatus may display indicia identifying specific fasteners by different colors.

As this information is projected onto the working surface of the structure, the technician may adjust the EDrill settings according to the fastener type projected on the working surface and apply the EDrill to the fastener head to remove it. In certain embodiments, the EDrill can be programmed so that the operator cannot turn the power on until the EDrill is activated. In certain embodiments, once the fasteners are removed, further instructions may be projected onto the working surface, guiding the user to remove the skins and/or other exterior parts.

Once the skins are removed, the interior substructures may be inspected. The use may affix a third set of photogrammetric targets onto key locations in the substructure in the same fashion described above. Using photogrammetry equipment, the substructure and parts may be scanned by digital cameras, as the image data is imported into the 3D CAD software to generate a surface model corresponding to the dimensions of the substructure and parts. The substructure details, including fastener hole dimensions and any surface imperfections and their locations, may be visually captured by the digital cameras to substantial accuracy.

After removing the outer skins and inspecting the substructure and all parts, components, accessories and other items, faulty structure parts and components may be reconditioned and restored. After reconditioning and restoring the structure parts, the structure may be reassembled.

Initially, the new or reconditioned skins and/or parts may be attached to the substructure by temporary fasteners, for example, by Cleko fasteners or similar attachments tools. Temporary fasteners may be used to retain or otherwise hold certain portions of the skin or replaced part in place while the user fastens other portions of the skin or replaced part. Thus, preventing movement of the skin or replaced part as the skin or part is reattached to the substructure.

In embodiments where a new skin is replacing an old skin, the image projectors may project each fastener hole location onto the newly installed skin. The EDrill may, further, be guided by the image projectors to a respective fastener location and new pilot holes may be drilled into the new skin by the EDrill drill.

In certain embodiments, after the new fastener holes have been drilled into the new skin and inspected, the image projectors may display each different type of fastener by projecting color-coded indicia on the working surface corresponding to the type of fastener in the correct sequence for reassembly. For example, the 0.25 inch fastener locations may be identified by projecting a series of “Blue” circles onto the working surface and after the fasteners have been installed, the image projectors may identify 0.375 inch fastener locations by projecting a series of “Yellow” stars onto the working surface. In this way, the user needs only to match the fastener's storage bin color with the color if the indicia illuminated on the skin.

According to another embodiment of the present disclosure, a method for refurbishing a structure is provided. The method includes constructing a fixture for supporting the structure, scanning the fixture with an imaging device, the imaging device being in electrical communication with a central processing unit which generates a three-dimensional surface model representing the external surfaces of the fixture and a simulated two-dimensional reference plane extending through the center of the fixture, installing the structure within the fixture, the structure having outer surfaces, and scanning the outer surfaces of the structure with the imaging device to determine the peripheral dimensions of the structure and the location of fasteners coupled to the outer surfaces to structure, wherein the location of each fasteners is defined by a rivet hole and the central processing unit generates a surface model representing the three-dimensional dimensions of the aerostructure. The method further includes removing fasteners securing the outer surfaces to structure, the fasteners being removed by an automated drill in electrical communication with the central processing unit, removing the skin from the structure such that a substructure of the structure is exposed, and scanning the substructure with the digital cameras, wherein the central processing unit generates a three-dimensional surface model representing the external surfaces of the substructure. Finally, the method further includes providing a new skin, the new skins being scanned by the digital cameras, wherein the central processing unit generates a three-dimensional surface model representing the surfaces of the new skins, drilling new fastener holes into the new skin at locations on the new skin corresponding to the fastener locations in the replaced skin, and fastening the new skin onto the substructure.

Other devices, apparatus, systems, methods, features and advantages of the disclosure will be or will become apparent to one with skill in the art upon examination of the following figures and detailed description. It is intended that all such additional systems, methods, features and advantages be included within this description, and be protected by the accompanying claims.

### BRIEF DESCRIPTION OF THE FIGURES

The present disclosure may be better understood by referring to the following figures. The components in the figures are not necessarily to scale, emphasis instead being placed upon illustrating the principles of the disclosure. In the figures, like reference numerals designate corresponding parts throughout the different views.

FIG. 1 is a schematic view of an exemplary system for refurbishing a structure, according to the teachings of the present disclosure.

FIG. 2 is a perspective view of the structure assembly of FIG. 1.

FIG. 3 is a front view of the holding fixture of FIG. 1.

FIG. 4A is a front elevation view of a holding fixture with photogrammetric targets affixed thereto.

FIG. 4B is a schematic view illustrating how the digital cameras scan the structure assembly of FIG. 1.

FIG. 4C is a schematic view illustrating how a three-dimensional model is generated by photogrammetry.

FIG. 5 is a partial perspective view of the structure assembly of FIG. 1.

FIG. 6 is a front elevation view of the structure assembly of FIG. 1.

FIG. 7 is a perspective view of the holding fixture of FIG. 1 coupled with attachments.

FIG. 8 is a perspective view of the structure assembly of FIG. 1, where the front skin is removed from the aerostructure.

FIG. 9 is a partial perspective view of the structure assembly of FIG. 8.

FIG. 10 is a partial perspective view of the structure assembly of FIG. 1, where all of the skins are disassembled from the aerostructure.

FIG. 11 is another partial perspective view of the structure assembly shown in FIG. 10.

FIG. 12 is a perspective view illustrating an exemplary E drill removing a fastener from the aerostructure skin, according to the teachings of the present disclosure.

FIG. 13 is a partial cross-section view taken along line A-A in FIG. 12.

FIG. 14 is a perspective view illustrating the E drill of FIG. 12 being guided by the Work Instructions projected by the image projectors onto the working surface.

FIG. 15 is a perspective view of illustration how Work Instructions may projected onto the working surface of the substructure by the image projectors.

FIG. 16 is a partial perspective view illustrating how photogrammetric targets may be affixed to the substructure.

FIG. 17 is a schematic view illustrating how a new fastener holes may be drilled in a new skin that corresponds with and existing fastener hole the substructure.

FIG. 18 is a top view of an E drill reassembling the skin to the substructure, according to the teachings of the present disclosure.

FIGS. 19A-19C is a flow diagram illustrating one example of a process of repairing a structure, according to the teachings of the present disclosure.

### DETAILED DESCRIPTION

In the following description and in the figures, like elements are identified with like reference numerals. The use of “e.g.,” “etc,” and “or” indicates non-exclusive alternatives without limitation, unless otherwise noted. The use of “including” or “includes” means “including, but not limited to,” or “includes, but not limited to,” unless otherwise noted.

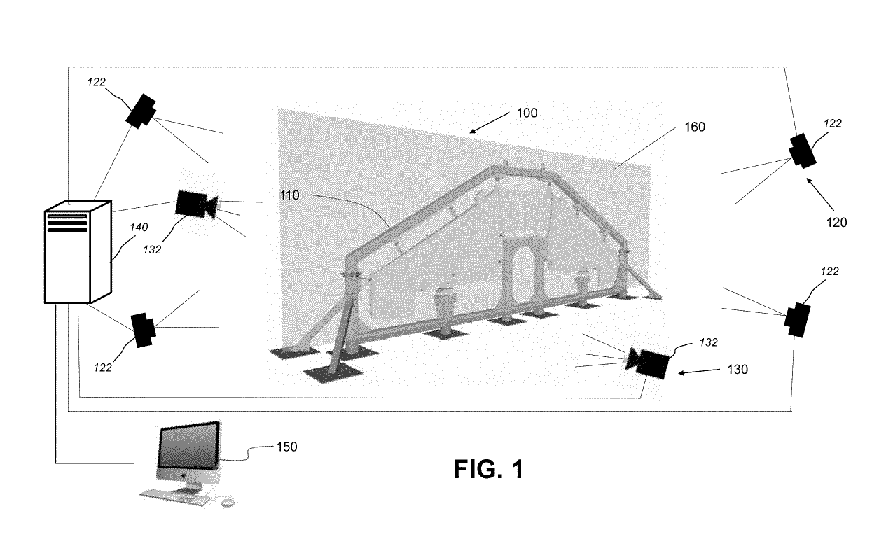

Referring now to the drawings, FIGS. 1-19C illustrate certain exemplary embodiments of a system and method for refurbishing mechanical structures according to the teachings of the present disclosure. The exemplary structures illustrated herein are aircraft structures, also referred to herein as aerostructures. However, the system and method of the present disclosure are suitable for refurbishing any mechanical structure. The system and method of the present disclosure facilitate highly complex structural repairs and reconstruction with the aid of photogrammetry. The metrology tools used in the present disclosure are accurate in all three dimensions.

The method generally includes designing and constructing a holding fixture for suspending a structure needing repair in an upright fashion. Once the fixture is constructed, a first set of photogrammetric targets may be affixed to a surface of the fixture at certain locations about the fixture. Once the targets are placed on the fixture, the fixture may be scanned by digital cameras to determine its geometrical dimensions. The digital cameras are in electrical communication with a central processing unit (CPU). The digital cameras transmit data to the CPU. The CPU processes the data and imports it into a three-dimensional (3D) computer-aided design (CAD) software system that generates a surface model depicting a 3D replica of the holding fixture and a simulated reference plane extending through the center of the fixture.

Once the simulated reference plane is generated, the structure needing repair may then be installed into the fixture so that the entire structure, including the substructures and parts of the main structure, is secured in an upright fashion. Once the structure is secured to the holding fixture, a second set of photogrammetric targets may be affixed to outer surfaces of the structure at certain locations about the structure.

After the second set of targets have been placed about the skin, the structure may be scanned by the digital cameras to dimensionally locate the structure (via photogrammetry) relative to the first set of photogrammetric targets and the simulated geographical plane. The data collected by this digital imaging technique is imported into the 3D CAD system, which generates a surface model depicting a 3D replica of the structure.

Once the structure is secured in the holding fixture and dimensionally located, the structure may be disassembled. During disassembly, an EDrill may be used to sever the fastener or bolt heads of the fasteners securing the structure. During disassembly, image projection equipment coupled to the CAD system may project each fastener type onto the structure's working surface (i.e., the skin) to assist the user in locating the bolt heads to be removed. For purposes of this disclosure, the “working surface” refers to the surface of the skin, a part, or substructure. Also for purposes of this disclosure, any information projected onto the working surface of the skin, a part, or substructure to instruct the user in any phase of the refurbishing process may be referred to as “Work Instructions” or “Work Cards.”

As the fastener types may have been programmed into the 3D CAD software's database, in certain embodiments, the video projection may be instructed to project specific fasteners, identifying them by different colors.

In certain embodiments, the procedures for identifying the fasteners to be removed may include (1) selecting one fastener type; (2) video projecting a reference indicia (i.e., a circle) onto the skin in a selected color about the fastener head; and (3) identifying the fastener by projecting its part number onto the skin next to its respective reference indicia. As this information is projected onto the working surface of the structure, the user may sets the EDrill settings to the fastener type projected on the working surface and apply the EDrill to the fastener head to sever it. In certain embodiments, the EDrill can be programmed so that the operator cannot turn the power on until the EDrill is activated (e.g., power turned on), preventing damage to the aerostructure due to the EDrill being placed over the wrong fastener.

Once the bolt heads are severed from the fasteners, the fasteners may be removed and the structure may be disassembled, i.e., the skin may be removed from the structure. As the various fasteners are removed, in certain embodiments, the technicians may insert Clecko fasteners (“Clekos”), i.e., holding pins or fasteners used to temporarily fasten sheets of material together, that hold the skins or parts in place so the skin or parts may stay in place while work is done on the structure. The system may project Work Instructions onto the working surface, showing the user where Clekos should be installed as the fasteners are removed. Once the fasteners are removed, further instructions may be projected onto the work surface, guiding the user to remove the Cleckos in a certain pattern so that removing the skins or exterior parts may be easily performed. Support equipment may be used when necessary to assist the user when the user is removing large, cumbersome skins or parts.

Once the skins are removed, the interior of the structures may be inspected. The technicians may install a third set of photogrammetric targets onto key positions of the substructure in the same fashion as before. For example, the targets are places so that each of the components of the substructure can be located. Using photogrammetry equipment (i.e., the digital camera), the substructure and parts are scanned and the data is imported into the 3D CAD software to generate a surface model depicting a 3D replica of the substructure and parts. Various details, including fastener hole dimensions and any surface imperfections and their locations, may be visually captured using the accuracy of the photogrammetry system. With photogrammetry, even the details like nut plates, surface paint differences, dents, scratches are visible. This provides technicians with physical, easy to identify reference data.

Upon removing the outer skins and inspecting the substructure and all parts, components, accessories and other items, the parts and components may be reconditioned and restored. In some exemplary operations, production of the replacement parts may begin in parallel with the disassembly process so that lead times for the replacements can be as short as possible.

Generally because replacement or new skins and parts have no fastener holes, CAD models of the new skins and the previously stored dimensional data of the substructure may be used to determine where new fastener holes need to be drilled in the new skins and parts. The fastener locations may be based on the dimensional location of the hole at the inside mold line (IML) (i.e., the inner surface of the skin). The new skin's CAD model may be laid over the CAD model of the substructure and the 3D CAD software targets where the new fastener holes need to be drilled to match their locations to the existing substructure fastener hole locations.

Using the image data stored in the 3D CAD system, the respective fastener hole locations may be projected onto the working surface of the new skins, and tooling holes may be drilled into the new skins and parts. By installing these tooling holes, surface are of the skin may be located and centered, and all the digitally scanned holes' positions with respect to the skin and the substructure may then be determined.

Once the skins and/or parts are is attached to the substructure by Cleckos or similar temporary attachments tools, the image projectors may project each fastener hole location onto the new skin. The EDrill may be guided by the image projectors and the CAD software to the respective fastener location and new pilot holes may be drilled into the new skin by the EDrill drill. The EDrill is guided by photogrammetric targets coupled the drill, which enables the digital cameras and the CAD software to “locate” the EDrill relative to the fastener head.

Next, the finish holes and countersinks may be drilled and reamed into the new skins. For this step, a specialized, high-precision drill, for example a Spacematic drill or other suitable device, may be used to drill both the fastener hole and the countersink in one operation. This drill may be operatively coupled with 3D CAD software in a fashion similar to the EDrill. This drill may be guided to the pilot holes and when it is centered at the hole, the power to the drill is engaged, activating suction devices coupled to the drill so the drill may be locked in place when the fastener holes are being drilled. The image projector project each different diameter hole according to their drilling sequence. Each hole may be assigned a color that represents the type and diameter of the holes to be drilled.

In some exemplary operations, each group of fastener holes are drilled, countersunk and if required, reamed. If a fastener holes require coldworking, the image projectors project these Work Instructions so they are displayed on the working surface, next to the fastener hole. Cleckos may be used to secure the skins as the holes are being drilled into them.

In some exemplary operations, after all of the new fastener holes have been drilled and inspected, the image projectors may display each different fastener type by color-code on the working surface according to their sequence for reassembly. There is often a pattern and sequence that is followed as new fasteners are installed into the skin and the Work Instructions may be displayed next to each fastener hole, showing grip, torque, or other data needed for fastener installation. Part bins that hold the different fasteners may be color coded according the color projected for the respective holes on the skin surface. The user needs only to match the fastener's part bin color with the hole color illuminated on the skin.

The fasteners may be installed into the new skins and parts by conventional or automated tools (rivet guns, HiLok Tools, ect.). Once all the fasteners are installed, a final inspection may be made of structure.

FIG. 1 is a schematic view illustrating one example of an implementation of a system 100 for refurbishing an aerostructure according to the teachings of the present disclosure. The system 100 may include a structure assembly 110, an imaging device 120, and an image projection apparatus 130, where the imaging device 120 and the image projection apparatus 130 are electrically coupled to a CPU 140. The imaging device 120 and the image projection apparatus 130 may be electrically coupled to the CPU 140 by electrical wiring or cabling, wireless transmission, or any other suitable means.

The imaging device 120 may include one or more digital photogrammetric cameras 122 positioned at various locations about the structure assembly to capture images of the structure along various lines of sight. In certain embodiments, the digital cameras may comprise a compact, super zoom, high definition, digital single lens reflex (DSLR), full frame, line-scan, or any other suitable camera. Once the images are captured, the imaging device 120 transmits image data to the CPU 140, where the data is stored. The CPU may be coupled to a computer monitor 150 where the processed image data simulating the structure assembly 110 may be viewed by the user as a 3D surface model.

Similarly, the image projection apparatus 130 may include one or more image projectors 132 positioned at various locations about the structure assembly 110 to display alphanumeric images on the surfaces of the structure being repaired. The image projectors 132 may include an image data generator for generating display image data representing a display image to be displayed by the computer monitor 150 or on a projection surface by using source image data. In certain embodiments, the image projectors 132 may comprise a liquid crystal display (LCD), digital light processing (LCD), light-emitting diode (LED), laser, plasma, liquid crystal on silicon (LCos), or any other suitable projection device.

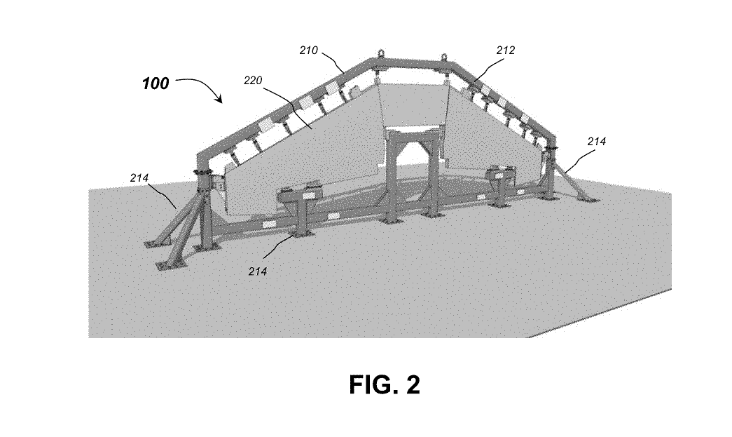

FIG. 2 illustrates a perspective view of an exemplary embodiment of the structure assembly 110. The structure assembly 110 includes a holding fixture 210 that suspends a structure 220, e.g., an aircraft wing, for repair. The fixture 210 may be designed with an open work area so the structure 220 can be disassembled/reassembled without any obstruction from the fixture 210. The fixture 210 also gives the repair technician(s) total access to the work area. The fixture 210 is also designed to provide the photogrammetry and video projection equipment with unobstructed views and visual access to the surfaces of the structure 220.

The fixture 210 may be constructed of a unitary piece of material or of various members that may be detachably assembled together. For example, in certain embodiments, pins and bolts may be used to attach each part of the fixture 210 together. This eliminates the need to weld large fixtures. The fixture 210 may include a frame 212 and a plurality of support stands 214.

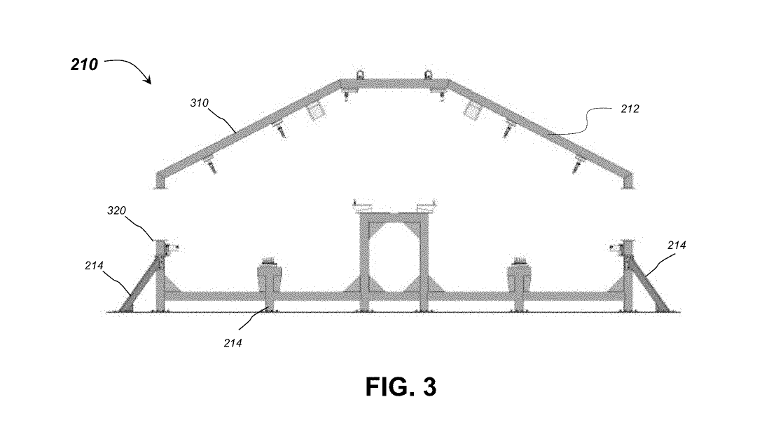

Referring to FIG. 3, a partially exploded front view of the exemplary fixture 210 constructed to repair an aircraft wing is illustrated. As shown, the fixture frame 212 may include an upper frame 310 and a lower frame 320.

The fixture 210 may be constructed of metal, wood, polyvinyl chloride (PVC), or any other suitable material. In certain embodiments, materials used to construct the fixture 210 may be the same or similar material as the structure being repaired. This may reduce the need to manage thermal expansion and contraction of the fixture 210 and the structure and may provide fixture parts that can be reused on different shape structures. The fixture 210 may be designed so that the inside dimensions of the fixture 210 correspond to the perimeter dimensions of the structure needing repair. This way, the attachment fittings that hold the structure's parts and subcomponents may be better constructed to hold the structure.

Once the fixture 210 is assembled, in certain embodiments, the surface of the fixture 210 may be sprayed with a flat coating, like talc or a powder to reduce reflection of incident light from any shiny, reflective surfaces of the fixture 210.

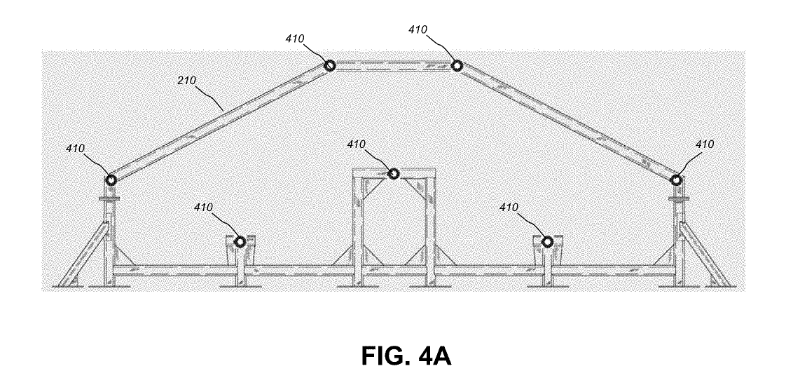

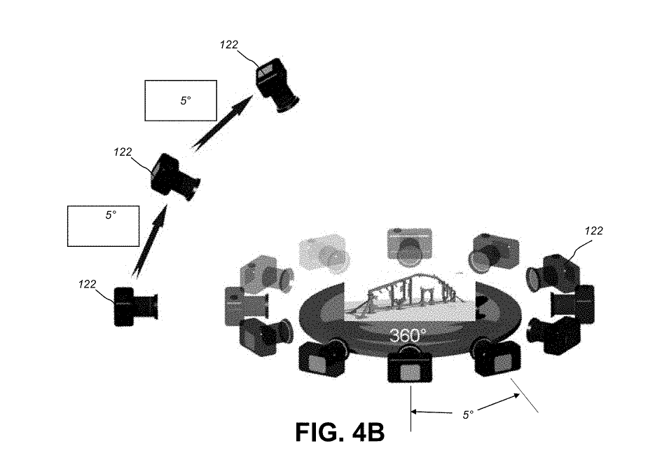

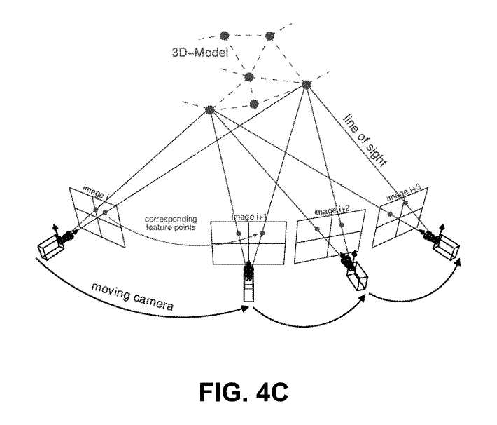

Turning now to FIG. 4A, a plurality of photogrammetric targets 410 may be affixed to front and/or back surfaces of the fixture 210 about its periphery. The targets 410 may be constructed to a suitable size and shape so that the digital cameras 122 (FIG. 1) may detect them. For example, in certain embodiments, the targets 410 may comprise a circular shape having a diameter of approximately 0.75 to 1.0 inches. In other embodiments, the targets 410 may comprise a square, triangular, diamond, or any other suitable geometric shape. The targets 410 may be affixed to the fixture 210 by adhesives, hook-and-loop fasteners, or any other suitable means. To facilitate detection by the digital cameras 122, the targets 410 may be colored or embossed with certain images, such as having black-and-white target images printed on them. The position of the targets 410 in FIG. 4 are illustrated by way of example only.

After the targets 410 are affixed to the fixture 210, the fixture 210 may be scanned by the digital cameras 122 to determine the dimensions of the fixture 210. As used herein, the terms “scan,” “scanned,” or “scanning” shall mean capturing a series of object images along various lines of sight (i.e., at different height locations and camera angles).

Referring back to FIG. 1, the digital cameras 122 and image projectors 132 may be positioned about the structure assembly 110 such that there are no obstructions or bright lighting that might affect the performance of the equipment. The digital cameras 122 may be positioned at angles to create triangulation. The cameras may be positioned around the fixture 210, as further described below. The image projectors 132 may be positioned relative to the structure assembly such that their light may be clearly projected on the working surfaces.

Each cameras 122 may photograph the lighted surfaces of the structures from its angle. The combination of the cameras 122 taking photos at different angles enables the system to pick up the x, y z locations of the surface of the fixture 210. The targets 410 may be placed on different planes of the fixture, as these targets are reference points for the cameras 122. Image data is collected in the high-resolution pixels and a “point cloud” (i.e., a set of data point defined by X, Y, and Z coordinates) is imported into the CPU 420. The digital cameras 122 electronically communicate with the CPU 420. The digital cameras 122 transmit data to the CPU 420 which imports the data into a 3D CAD software system that generates a surface model representing the external surfaces of the fixture 210 and a simulated geographical “zero” or reference plane 160 extending through the center of the fixture 210 (FIG. 2).

In certain embodiments, the reference plane 160 may be used as a reference to center the aerostructure 220 as it is installed into the fixture 210. In instances where the structure assembly 110 is somehow moved, the reference plane 160 may be used as a target plane to re-center the structure assembly 110 between the photogrammetry equipment (i.e., the digital cameras 122 and the image projectors 132).

As shown in FIG. 4B, the digital cameras 122 may scan the fixture 210 by capturing digital images of the fixture 210 along various lines of sight. For example, in certain embodiments, the digital cameras 122 may be positioned about the structure assembly 110 in common horizontal and vertical planes. In this embodiment, the cameras 122 may collectively form a doom or semi-spherical array that encloses the structure assembly 110. In this array, the digital cameras 122 may be spaced apart at angular increments of, for example, 10°, and more preferably 5°.

In other embodiments, one or more digital cameras 122 may be translated radially about the structure assembly 110 in both horizontal and vertical directions at angular increments of, for example, 10°, and more preferably 5°.

As the holding fixture 210 is scanned, the digital cameras 122 are configured to transmit image data corresponding to the dimensions of the fixture 210 to the CPU 140 for processing and storage. The CPU import the data into a 3D CAD software that generates a surface model simulating a 3D replica of the fixture 210. In other embodiments, the CAD system may generate a solid model, wire frame, point cloud, or any other suitable computer generated model.

As illustrated in FIG. 4C, the image data may be generated by photogrammetry. Photogrammetry is the process of creating 3D models with textures of existing objects and spaces by shooting many overlapping photos from different camera angles (i.e., lines of sight). Photogrammetry relies on feature detection, meaning the 3D CAD software will process all of the image data (i.e., photos) and detect common points between any pair of overlapping images. Many thousands of features may be detected, with each pair having significant overlap.

Using the 2D features in a pair of images simultaneously, the CAD software is able to solve for the camera and feature point location in 3D space. The 3D CAD software simultaneously solves all pairs creating accurate camera locations and surface points for all the images processed. Then it reconstructs the geometry and creates textures using the positions of the cameras. To get high fidelity, there must be plenty of overlap between the captured images. In certain embodiments, the digital cameras may capture images at approximately 1,500 to 4,000 frames-per-second (FPS).

Some objects will not work with photogrammetry. For example, transparent, translucent, shiny objects, heavily speculator, or reflective objects all look different when viewed from different angles and can cause the matching algorithms to fail. One solution for scanning these types of objects is to coat the structure with a matte chalk spray paint found in most art stores. Photogrammetry can be used to obtain reliable information about physical objects. Photogrammetric analysis may use high-speed photography and/or remote sensing to detect, measure and record complex 2-D and 3-D fields by feeding measurements and imagery analysis into computational models to successively estimate, with increasing accuracy, the actual 3-D fields.

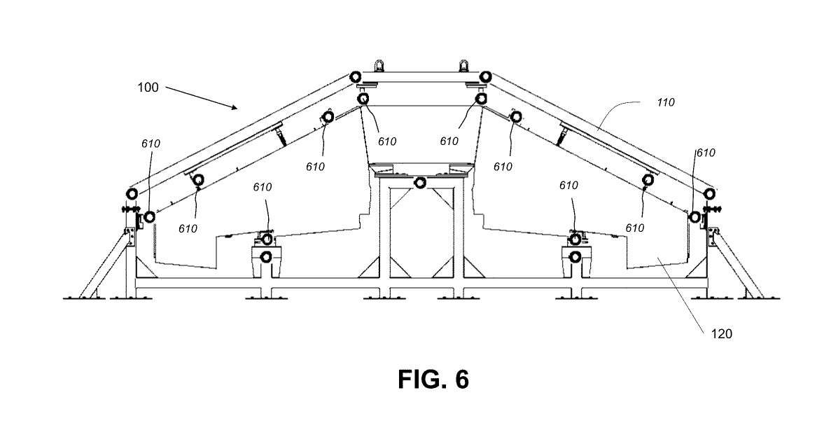

In general, the targets 410 and 610 (FIG. 6) attached to the holding fixture 210 and aerostructure 220 serve as reference points for the CAD software. In particular, to increase the fidelity of the computer generated surface models simulating the holding fixture 210 and aerostructure 220, the digital cameras 122 may capture digitally zoomed or enhanced images of the fixture 210 and structure 220. Since the cameras 122 may only capture partial images of the entire structure, as the CPU 140 (FIG. 1) processes multiple images, the targets 410 and 610 (FIG. 6) enable the CAD software to identify the location of one captured image relative to another. For example, if two captured images share a common target, then the CAD software will know that portions of the images correspond to each other. In certain embodiments, each target 410 and 610 (FIG. 6) may be assigned a number and display a unique black-and-white image identifying the target (e.g., similar to a bar code). Therefore, as the location of each target 410 and 610 (FIG. 6) is known relative to the structure dimensions, the CAD software is able to determine the location of each captured image relative to the structure dimensions based on the target image(s) captured in the image.

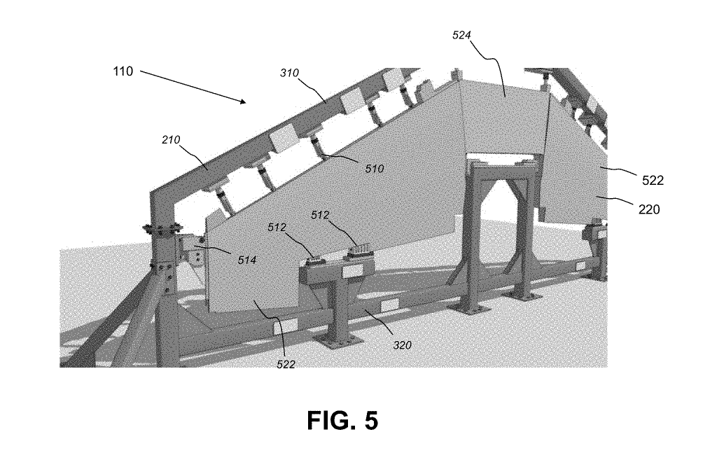

FIG. 5 is a partial perspective view of the structure assembly 110. As shown, the structure 220 needing repair may be installed into the fixture 210 and secured in an upright position by one or more attach fittings 510 and base fittings 512. In the example shown, the aerostructure 220 is an aircraft wing having a first wing portion 520 and a second wing portion 522 coupled together by a wing box 524.

The attach fittings 510 are elongated members that couple an upper portion of the aerostructure 220 to the upper frame 310. In certain embodiments, the attach fittings 510 may be adjustably coupled to the upper frame 310 to permit the fittings 510 to be detachably attached to the aerostructure 220 at certain desired locations along the structure's upper periphery. The attach fittings 510 may be attached to the upper frame 310 and the structure 220 by fasteners, clamps, or any other suitable means. It is desired that the attach fittings 510 be attached to the aerostructure 220 in a manner that does not obstruct the digital cameras from capturing photographic images of the structure's upper periphery.

The base fittings 512 are members coupled to the lower frame 320 that support a lower portion of the aerostructure 220. In certain embodiments, the base fittings 512 may be adjustably coupled to the lower frame 320 to permit the fittings 512 to be adjusted according to the structure dimensions. The base fittings 512 may be attached to the lower frame 320 by fasteners, clamps, or any other suitable means.

In certain embodiments, end fittings 514 may be coupled to the lower frame 320 to support outer ends of the structure 220. The end fittings 514 may be coupled to the lower frame 320 by fasteners, clamps, or any other suitable means.

As will be described below, attachments may be used to secure the substructures and internal parts of the structure 220. Thus, it is advantageous to install the structure 220 into the fixture 210 in such a way that the dimensional characteristics of the structure 220 are clearly visible, especially locations (i.e., attach points) where the structure 220 is coupled to or otherwise assembled with other structures, such as an aircraft fuselage in this example.

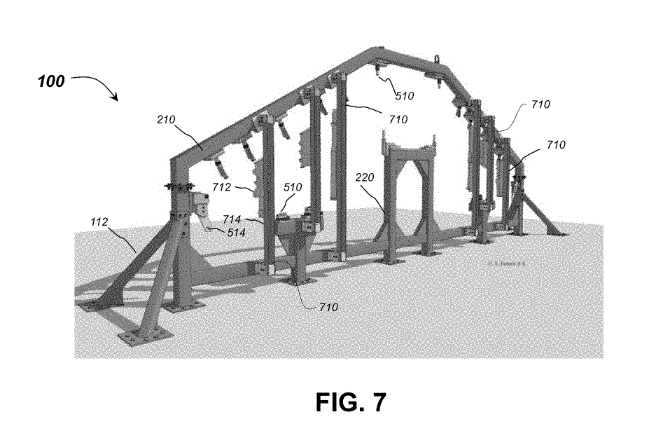

The attach fittings 510 may be designed so that the structure 220 can be disassembled without any movement of the substructure or any of the adjoining parts or components. In addition, attachments (as described in FIG. 7) may be used to secure the structure 220 so individual parts can be removed for repair or replacement without jeopardizing any movement, thereby protecting the positions of adjoining parts and any fastener hole locations.

Referring now to FIG. 6, once the structure 220 is secured to the fixture 210, a second set of photogrammetric targets 610 may be affixed to the outer surface (i.e., “the skin”) of the aerostructure 220 at certain locations about the structure. Similar to targets 410 (FIG. 4), targets 610 may be constructed to suitable sizes and shapes so they may be detected by the digital cameras 122 (FIG. 1). For example, in certain embodiments, the targets 610 may comprise a circular shape having a diameter or approximately 0.75 to 1.0 inches. In other embodiments, the targets 410 may comprise a square, triangular, diamond, or any other suitable geometric shape. The targets 610 may be affixed to the structure 220 by adhesives, clamps, mechanical or hook-and-loop fasteners, or any other suitable means.

After the second set of targets 610 are affixed to the skin, the structure 220 may be scanned by digital cameras 122 to dimensionally locate (via photogrammetry) the structure 220 relative to the first set of photogrammetric targets 410 (FIG. 4) and the reference plane 160 (FIG. 1). The image data collected by this digital imaging technique is imported into the 3D CAD software system (e.g., located in the CPU 420), which generates a surface model simulating a 3D replica of the structure 220.

In addition to determining the dimensions of the structure 220, during the scanning process the digital cameras 122 (FIG. 1) may detect the location of fasteners, which are defined by fastener holes (not shown) machined into the skin of the structure 220. The fasteners may be detected by, for example, referencing the first and second sets of photogrammetric targets 410 and 610 and the reference plane 160. The fastener dimensions and coordinates may be stored in the 3D CAD software database executed by the CPU 140.

Once the aerostructure 220 is secured to the fixture 210 and dimensionally located, a preliminary inspection of the structure 220 may be conducted, either manually or electronically, for structural defects, such as damage, corrosion, fatigue/stress cracking of the structure. In certain embodiments, the inspection may be performed by non-destructive inspection or non-destructive testing (NDT/NDI inspection), primarily with radiography and ultrasonic equipment, to detect defects, if any, in the structure 220. This process will be described in further detail below. In certain embodiments, the NDI equipment may be adapted to carry one or more target images, enabling the CAD software to determine the location of the equipment relative to the simulated 3D surface model of the aerostructure 220 during inspection.

By identifying defects early on, replacement parts provisioning can begin early in the repair process. These procedures may be defined in Work Cards that include Work Instructions for the technicians.

During the structure scanning process, the digital cameras 122 may also detect the location and dimensions of part or substructures of the structure 220. Referring to FIG. 7, the holding fixture 110 may include one or more attachments 710 adapted to secure the substructures or parts of the structure 220. Each attachment 710 may include a support bracket 712 adjustably coupled to a support bar 714. In certain embodiments, the support bracket 712 may be adjusted up-and-down and retained in place at a given height along the support bar 714 by screws, latches, spring-loaded pins, or other suitable means.

Opposing ends of the support bar 714 may be detachably coupled to the upper frame 310 and lower frame 320 of the fixture 220 by, for example, fasteners, claps, brackets, or any other suitable mechanical means. In certain embodiments, the support bars 714 may comprise two or more telescoping sections that permit the support bar 714 to be adjusted according to the dimensions between the upper frame 310 and lower frame 320.

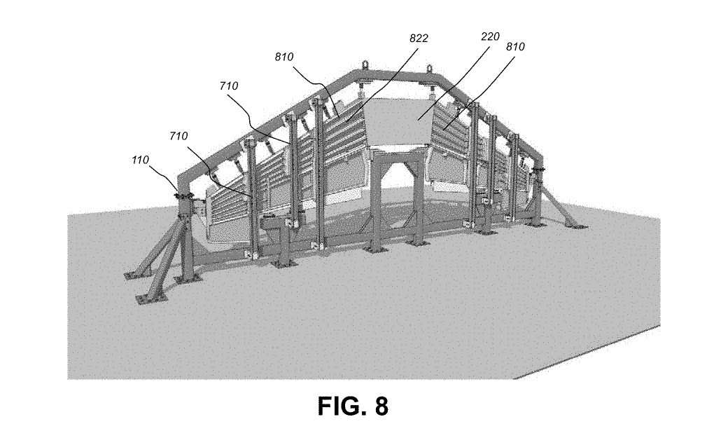

In certain embodiments, the structure 220 must be disassembled to access the substructures. In the present example, the structure 220 may be disassembled, for example, by removing rivets or fasteners securing the skin to the structure 220. FIGS. 8-11 illustrate the structure 220, which in this example is an aircraft wing, installed and secured in the fixture 210 at various stages of disassembly.

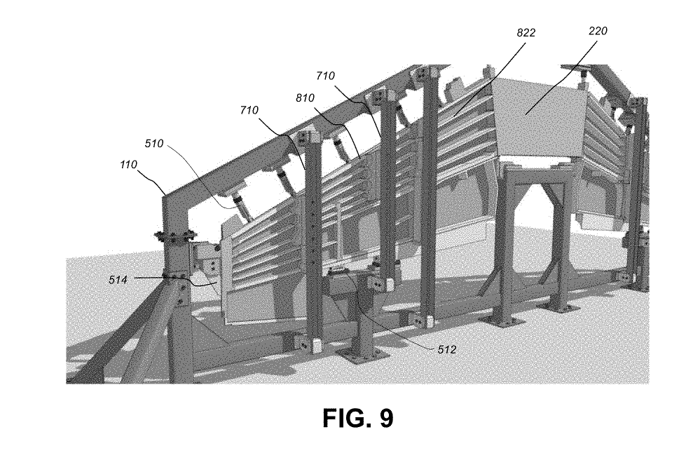

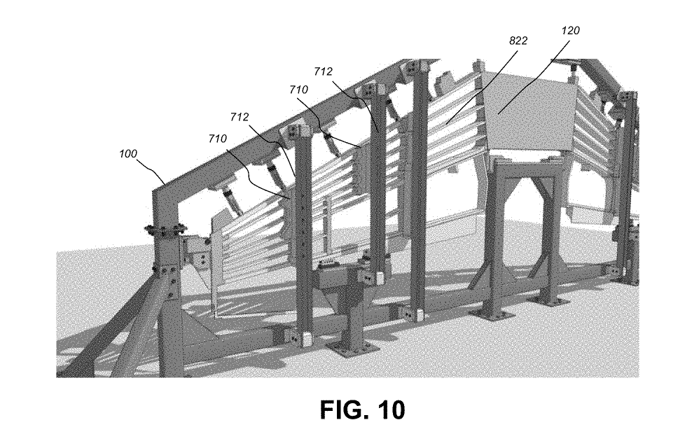

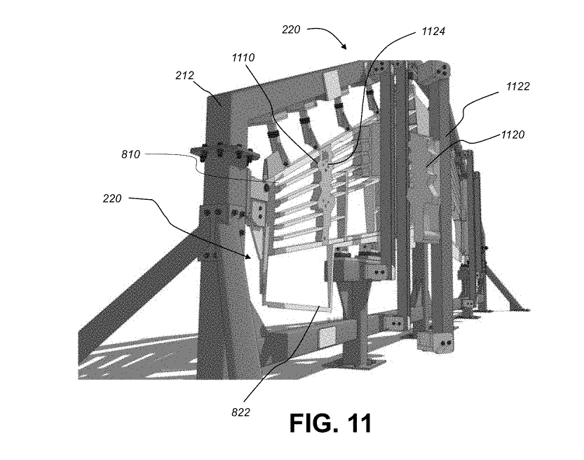

Once the front skin of the structure 220 is removed, as illustrated in FIGS. 8-9, attachments 710 coupled to the fixture frame 212 may be adjusted to secure internal substructures 810 formed by spars 822 and ribs 1110 (FIG. 11) of the aerostructure 220. FIGS. 10-11 show the aerostructure 220 with both its front and back skins removed.

As better shown in FIG. 11, the support brackets 712 of the attachments 710 may correspond in shape and dimensions to the ribs 1110 of the aerostructure 220. As such, the support brackets 712 may be detachably coupled to the ribs 1110 to support the substructure 810. This advantageously allows the aerostructure 220 to be firmly secured to the fixture 210 when technicians are working on the structure 220 and its substructures. The support brackets 712 may be coupled to a corresponding rib 1110 by fasteners, clamps, or any other suitable means. In the example shown, the support bracket 1120 may include threaded holes (not shown) corresponding to the pattern of fastener holes 1124 formed in a corresponding rib 1110. FIG. 11 further illustrates how the attachments 710 are detached from the fixture frame 212.

In some exemplary operations, the fixture 210 and the aerostructure 220 may be scanned periodically as the disassembly process is performed. Depending on the size of the structure 220 and the level of work, the fixture 210 and structure 220 may be scanned several times so that any movement of either the fixture 210 or structure 220 may be recorded. If the system 100 moves, the repeated scanning can determine where and how much so corrective actions may be performed to ensure accuracy.

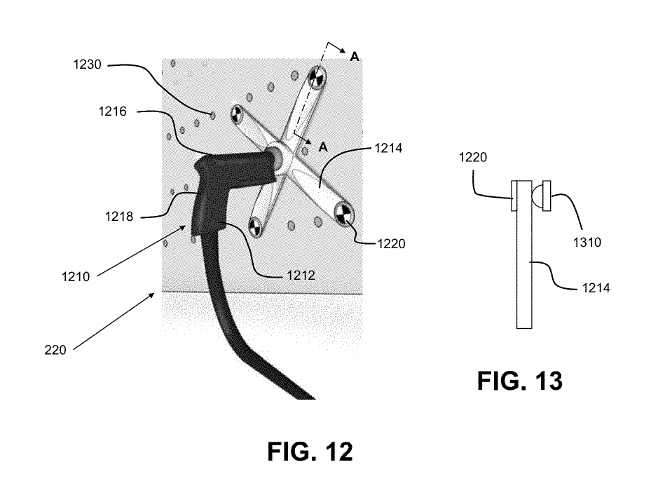

Referring now to FIG. 12, during disassembly, an electrical discharge machine (EDM) 1210, also referred to as an “EDrill”, may be used to sever fasteners or bolt heads of the fasteners 1230 securing the skin to the structure 220. EDMs cut material by way of electrical discharges. The EDrill 1210 is a small, lightweight drill, controlled by a programmable power supply. In certain embodiments, the EDrill 1210 may display a preprogrammed menu of fasteners such that when the operator selects a fastener type from the EDrill menu, and the EDrill automatically adjusts to the correct power settings for the fastener selected.

The EDrill 1210 may include a gun portion 1212 and one or more target members 1214 outwardly extending therefrom. The gun portion 1212 may include a receptacle 1216 and a handle 1218. Depending on the application, the receptacle 1216 may house a drill bit, for screwing in fasteners, or an automatic bolt cutter, for severing the bolt heads of the fasteners.

Each target member 1214 carries at a free end of the member a photogrammetric target image 1220 on one side, and a suction cup 1310, as shown in FIG. 13, on the other side. The photogrammetric targets 1220 enable the digital cameras 122 (FIG. 1) to locate the EDrill 1210 relative to the centerline of a fastener head. In certain embodiments, the digital cameras 122 (FIG. 1) and the CAD software may map the location of the targets 1220 relative to the photogrammetric targets 410 (see FIG. 3) affixed to the fixture 210 and photogrammetric targets 610 (see FIG. 6) affixed to structure 220 to determine the location of the EDrill 1210 relative to the fastener holes of the structure 220. The suction cup 1220 engages the working surface of the structure 220 to lock the drill 1210 in place when the drill 1210 is in operation, as discussed in detail below.

The target members 1214 may be designed to adapt to curved surfaces. In certain embodiments as shown in FIG. 12, the EDrill 1210 may include four target members 1214. The target members 1214 may be constructed of plastic, metal, composite, or any other suitable material. Because the EDrill 1210 may be designed to require very little physical force to hold it onto to a fastener, the fixtures and tooling disclosed herein do not have to be as robust as if conventional drilling were used.

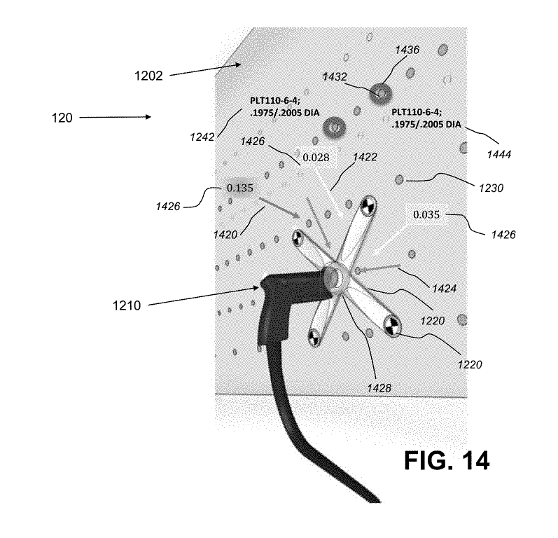

As mentioned above, the system 100 includes an image projection apparatus 130 (FIG. 1) that assists the operator in locating fastener heads for disassembly. As illustrated in FIG. 14, the system 100 (FIG. 1) may track the precise location of the EDrill 1210 by detecting the location of the target images 1220, and the image projectors 132 (FIG. 1) may display indicia, for example, arrows in different colors that guide the technician to the centerline of a selected fastener hole. For example, the image projectors 132 (FIG. 1) may assist the operator by guiding the EDrill 1210 to the correct fastener location by displaying on the skin or “working surface” 1402 colored arrows 1420, 1422, 1424 pointing the user toward each fastener head. In this example, a “Red” arrow identifies that the drill is far away, a “Yellow” arrow identifies that the drill is closer, and a “Green” arrow identifies that the drill is on target. The relative distance between the drill gun 1212 and the fastener head may also be displayed in colored boxes 1426, e.g., “0.135”, “0.028” and “0.035”.

When the EDrill 1210 is correctly positioned, the image projectors 132 (FIG. 1) may display a predetermined color 1428, e.g., a “Green” colored circle, along with an audible beep indicating that the EDrill 1210 is over the centerline of the fastener. In certain embodiments, when the EDrill 1210 is positioned over the fastener, target members 1214 may fix the gun 1212 in place by activating a vacuum that secures the EDrill 1210 to the working surface 1402 by vacuum suction. Once the EDrill 1210 is secured in place, electric current is powered on and the technician may proceed to sever the head of the fastener. The EDrill 1210 may be coupled to the CAD software and programmed so that the operator cannot turn the power on until the EDrill 1210 is positioned over a fastener, e.g., a “Green” colored circle 1428 is displayed, preventing the EDrill 1210 from causing any damage due to it being in the wrong location. Once the EDrill cutting cycle is complete, e.g., 8-10 seconds for most fasteners, the vacuum may be released and technician may proceed to the next fastener location, while being guided by the image projectors 132 (FIG. 1).

In some operations, there may be several different types of fasteners incorporated into a structure 220. As such, the CAD software may be adapted to process the structure 220 image data captured by the digital cameras 122 (FIG. 1) and export the data into a visual format such that information corresponding to each fastener type may be displayed on the structure's working surface 1202. In certain embodiments where work space is limited, Work Instructions may be displayed on a computer monitor placed close to the work area in lieu of projecting images onto the working surface 1402 of the structure 220.

As each fastener type may be programmed into the CAD software database, the image projectors 132 (FIG. 1) may be instructed by the software to display indicia identifying certain fasteners. For example, in the example illustrated in FIG. 14, a fastener 1432 may be identified or “called-out” by its part number and specifications 1444 and a color marker 1436, which in this example is a colored ring. In other embodiments, a fastener may be identified by markers having other geometric shapes.

During disassembly, the operator may move the EDrill 1210 to the fastener type displayed on the working surface 1402 and to apply the EDrill 1210 to the fastener head, e.g., to cut it off. Accordingly, the image projectors 132 (FIG. 1) may identify and display information about certain fasteners in sequence, such that a first set of fasteners made of a certain fastener-type are identified by indicia displayed on the working surface 1402 and, once those fasteners have been removed, indicia identifying a second set of fasteners made of a certain fastener-type by be displayed on the working surface 1402, and so on.

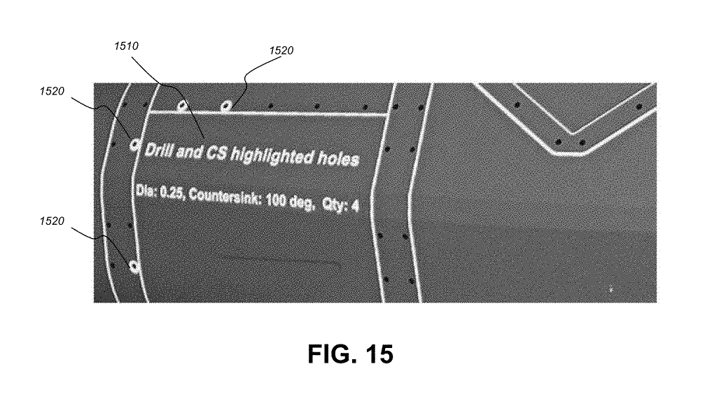

As best shown in FIG. 15, the image projectors 132 (FIG. 1) may also display Work Instructions, as depicted by reference numeral 1510, e.g., telling the user what type of fastener he/she is removing and where each of these fasteners are on the structure 220. In this example, the instructions tell the user to “drill and countersink the highlighted holes. There are four holes (1520) with 0.25 inch diameters and 100° countersinks.” The amount of time saved these projected instructions is significant because the technician does not need to refer to drawings or diagrams to identify where each fastener is and what type it is. In addition, the EDrill's preprogrammed power settings also saves time and reduces human error.

As described herein, the system of the disclosure may provide Work Instructions for the technicians. The Work Instructions may be projected onto a surface of a structure 220 being repaired. In certain embodiments, the Work Instructions may require that while the structure 220 is being worked on, the fixture 210 and the structure 220 are checked for their location periodically, for example, either every 60-90 minutes while work is being performed, or if there is any significant change in room temperature (e.g., over +/−7 degrees Fahrenheit). This may be performed by using the photogrammetry equipment to record the fixture 210 and structure 220 by location of the photogrammetric targets 410 and 610 shown figures above.

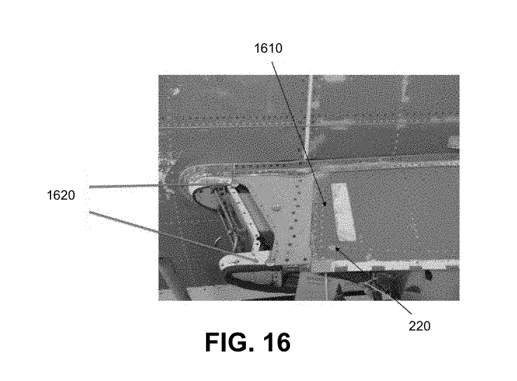

Referring to FIG. 16, in some operations, after the skins 1610 of the structure 220 have been removed, photogrammetric targets 1620 may be affixed to key locations in the substructure and the substructure may be scanned in the same fashion described above. The targets 1620 may be placed so that each of the components of the substructure can be located. The photogrammetry equipment may proceed to scan the substructure and parts that are now accessible after removal of outside skins 1610 and parts. The image data may then be imported into the CAD software. Details of the substructure, including fastener hole dimensions and any surface imperfections and their location may be digitally captured and simulated accurately using the photogrammetry system. With photogrammetry, even the details like nut plates, surface paint differences, dents, scratches can be visible. This provides the user with physical, easy to identify reference data.

In certain embodiments, the digital cameras 122 (FIG. 1) may capture the X, Y, Z dimensions of the inner surface, or inside mold line (IML) of the structure 220. The digital scanning process for the IML is similar to the digital scanning of the outside mold line (OML) (i.e., outer surface of the skin) where the targets are placed on the substructure to ensure accurate capture of the dimensional data. Special attention may be paid to the fastener holes, their locations, hole diameters and overall condition. This data may be recorded in the CAD software.

In some operations, with the skins or parts removed, inspection of the inside of the structure may be done, e.g., beginning with visual inspection where the user looks for signed of corrosion, damage and wear. Optical, or remote digital inspection equipment (e.g., portable borescopes and specialty video cameras) may also be used for hard to reach areas. Users may also use manual pin gages to spot-check some of the diameters of the fastener holes to compare with the photogrammetry results. Any damage or discrepant findings may be documented using methods and systems compliant with any applicable industry standards, e.g., AS9100 Quality Standards, and these faulty areas may also be added to the CAD software database so that exact locations of damage may be identified. Any parts and fasteners found to be in good condition may also be noted in the CAD software database.

Once the entire structure and subassemblies have be fully inspected, certain structure parts and components may be reconditioned and restored, based on the Work Instructions for the particular structure. Durable coatings, primers, paints, and/or sealants may be used whenever possible to improve the reconditioning process. The replacement coating, primers, paints, and/or sealants may be noted in the Work Instructions. The production of the replacement parts may begin in parallel with the disassembly process so that lead times for the replacements is as short as possible.

In certain operations, new skins may be assembled to the structure 220. The new skins or parts often have no fastener holes. Thus, corresponding fastener holes must be formed in the new skins or parts.

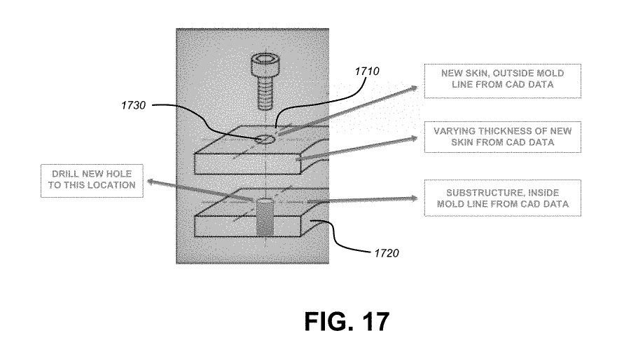

As such, after scanning and modeling a new skin or part, as illustrated in FIG. 17, using a combination of the OML and a CAD generated model of new skin 1710, and the dimensional data substructure 1720 or IML, the CAD software can determine where new fastener holes must be drilled. This location may be based on the dimensional location of the hole at the IML. The new skin's 1710 CAD model is laid over the CAD model of the substructure and the varying thicknesses of the new part 1710 are derived from the skin CAD model. The surface software targets where a new fastener hole 1730 needs to be drilled to match its location to the existing substructure fastener hole location.

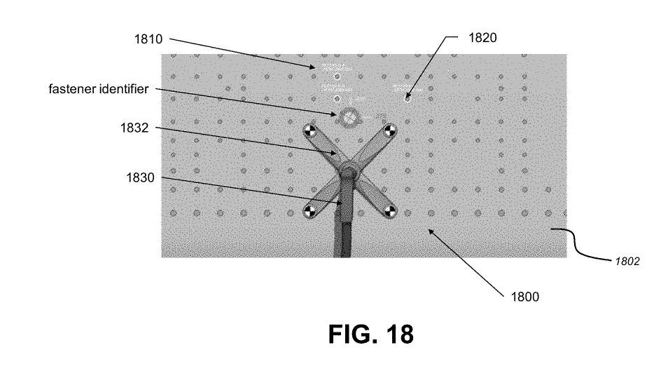

During reassembly, as illustrated in FIG. 18, once the substructure dimensions and features are recorded into the CAD software as previously described, the fastener hole locations and corresponding Work Instructions may be projected onto the surface 1802 of a new skin 1800. As shown, in certain embodiments, the Work Instructions 1810 may, for example, call for establishing “tooling holes” by locating one or more fastener holes located on the outermost surface of the new skin that correspond to the fastener holes of the substructure. In this example, four or more fastener holes may be used. By installing these tooling holes, the entire skin can be dimensionally located and the position of holes may be determined with respect to the skin 1800 and substructure (not shown). This can also be accomplished by affixing photogrammetric targets the new skin 1800 that correspond to targets attached to the substructure, then tooling holes can be established by following the Work Instructions 1810.

Once the new skin 1800 (or part) is attached to the substructure (not shown) by temporary fasteners, for example Clecko fasteners or other similar attach tools, the image projectors may project the hole locations 1820 onto the new skin. The EDrill 1830, with target members 1832, may be guided by the CAD software to the location where new pilot holes are to be EDM drilled. The light weight of the EDrill, coupled with the speed that the EDrill 1830 operates, saves both time and physical effort. The other distinct advantage is that the EDrill doesn't produce any metal shavings or FOD like manual electric drills produce.

In some operations, the next step is to drill and ream the finish holes and countersinks into the new skin. A spacematic drill, or an equivalent that drills both the fastener hole and the countersink in one operation, may be used to drill the skin holes. In certain embodiments, the spacematic drill may be adapted to include target members similar in structure and function to the target members 1214 coupled to the EDrill 1210. In these embodiments, the spacematic drill may be guided to the pilot holes by the CAD software and when the drill is centered over a pilot hole, the power to the drill, may be engaged, activating the suction devices on the target members so that the drill may be secured in place for the drilling operation. The image projectors may display each different diameter hole in sequence. Each hole may be assigned a color that represents the type and diameter of the holes to be drilled. The spacematic drill bits may also be color coded so the user can select the correct drill bits to use, based on their corresponding color.

Each group of holes may be drilled, countersunk and, if required, reamed into the new skin or part. If any of the holes require coldworking, the image projectors 132 (FIG. 1) may display these Work Instructions next to the hole. Clecos may be used to temporarily secure the new skins to the substructure as the holes are drilled.

After all the new skin holes are drilled and inspected, the reassembly process may begin. In certain embodiments, the image projectors 132 (FIG. 1) may display each type of fastener to be used in different color and in the correct sequence of reassembly. There is often a pattern and sequence that is followed as new fasteners are installed into the skin. Work instructions may be displayed showing grip, torque, or other data needed to install the fasteners. Part bins holding the different fasteners may also be color coded according to the color of the holes displayed on the skin surface by the image projectors 132 (FIG. 1). Thus, the user need only to match the fastener's bin color with the illuminated hole color on the skin.

Once all the fasteners are installed into the skins, the Work Instructions may define the final inspection instructions. The CAD software may produce, for example, an AS9100 compliant inspection report, complete with matching certification traceability to each fastener's original equipment manufacturer (OEM) certification, the technician who performed the work, the time and date work was performed, operation temperatures, and other key inspection data.

The system 100 of the present disclosure, including the adapted target members, the photogrammetric equipment, and system software advantageously shortens the structure repair cycle time—from start to finish—by more than four times that of conventional methods. The system and method of the present disclosure may reduce the cost of repair by as much as 50% over the cost to repair a structure by using newly manufactured parts and structures.

In some operations, Work Instructions for NDI/NDT inspections of structures undergoing repair and reconstruction may follow the published procedures and requirements documented in the tech orders (T.O.s) usually published by a service customer, e.g., the Air Force, the Original Manufacturer (OEM) or combination of both. The system 100 of the present disclosure may use the newest, most advanced equipment that produces superior and cost-efficient results with minimal error.

For example, there are several types of NDI/NDT Inspection methods used in the aerospace industry. The types of NDI/NDT inspection methods that may be incorporated into the system's Work Instructions include: visual/optical inspection; penetrant inspection; magnetic particle inspection; Eddy current, ultrasonic, contact through transmission method, longitudinal wave, shear wave, rayleigh wave techniques, 360 degree rotational scanner system, and radiographic method, among others.

For example, in certain embodiments, for ultrasonic and Eddy current type inspections, the system may prefer the latest products, for example, the Olympus IMS OmniScan inspection equipment. The system may use OmniScan MX2 and EPOCH 1000 Phased Array with UT (Ultrasonic) that can be used for time-of-flight-diffraction (TOFD) and other indicators of corrosion and damage. Other Olympus inspection equipment includes an Eddy current array flaw detectors like the MX ECA/ECT that can be equipped with Bolt Hole Inspection attachments. Ultrasonic one-sided thickness gages may also be used where thicknesses need to be checked and when there is access only to one side of a structure.

The latest Olympus Omniscan products, including their Automated Fastener Hole Inspection System (AFIS), that is especially designed for aircraft may be used. Modern aircraft have millions individual components, with as much as half that amount often being some type of fastener. Aircraft fasteners come in many shapes and sizes and are inspected using many non-destructive tests (e.g., ultrasonic, Eddy current, remote visual, etc.) for damage in and around the fastener either with the fastener in place or after removal. Being able to inspect the area around the fastener for damage without removal adds valuable time savings to the NDI process and prevents further damage from the removal process itself. A novel portable automatic scanning system for aircraft fastener inspection has been developed for various military aircraft (F5/T38) that also has promise for other aircraft. It is built around the popular OmniScan portable phased array system.

By following the instructions on the system Work Cards, certain inspections may be performed with the equipment listed above so that any damage of substructure parts can be identified and added to new parts needed for the structure.

In certain embodiments, the inspection process may incorporate material hardness testing of components and individual parts in the structure. This is often recommended when the maintenance records for the structure (e.g., aircraft) are not as complete and detailed as they might be. Using handheld equipment like GE's Krautkramer DynaMIC, hardness testing can be quickly and cost effectively while the inspection process is being performed.

In certain embodiments, other Work Instruction may be provided when needed, e.g., verification of the material type, repair and reconstruction of structures that are for aging aircraft often require some validation, or test procedure to find out what the alloy type is of the material in the parts being repaired, replaced or reconditioned.

In certain embodiments, the system of the disclosure may incorporate the latest in radiography (x-ray) inspections using equipment such as the portable, handheld DXR250C-W and DXR250U-W wireless digital X-ray detectors from General Electric (GE). These units, are handheld, 8″ read for the ‘C’ unit, 16″ for the CU′ model. Thickness is about 1″ and weight is 5-10 lbs., making the units easy to move around the structures. It should be noted that the system Work Cards meet and exceed all the original requirements of the aircraft platform's T.O. but without the time, costs and cumbersome processing of traditional X-Ray film methods.

In some operations, the photogrammetry equipment described herein may need calibration before and/or during use. The photogrammetry equipment may be checked for calibration using a sampling bar. The sampling bar may be a bar with about 6-8 feet in length made of the same material as the structure 220. The sampling bar may have photogrammetric targets on it that have been premeasured at calculated conditions including room temperature. The photogrammetric equipment may be checked for calibration each time it is used and the results may be stored in the CAD software database.

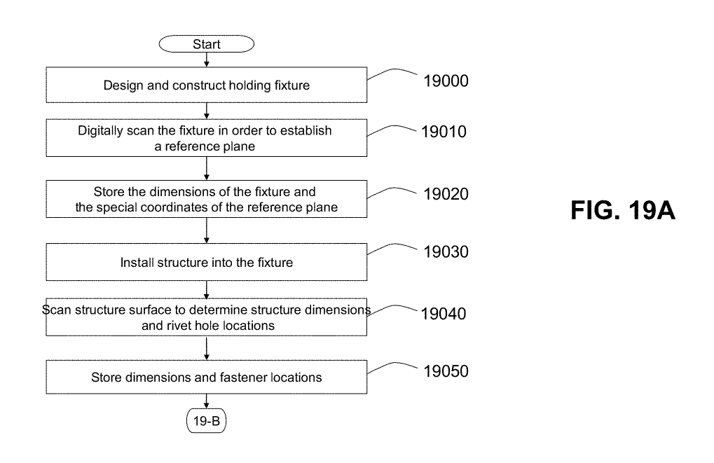

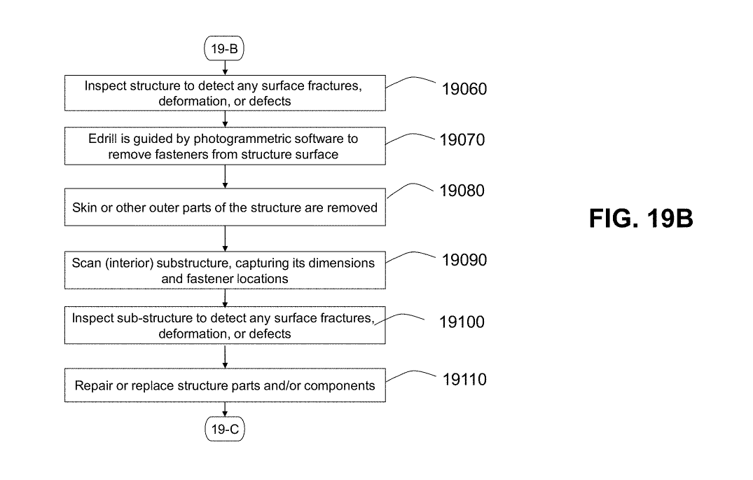

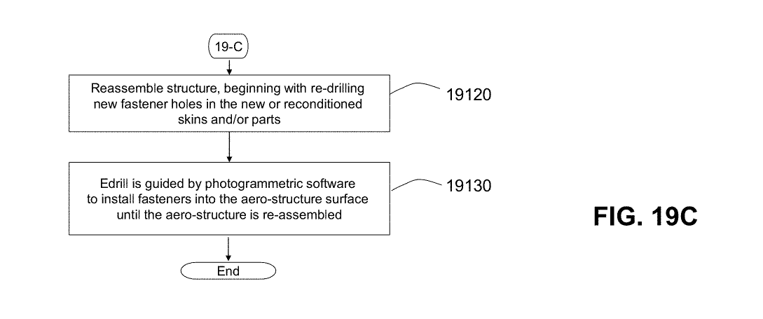

FIGS. 19A-C illustrate a flowchart of one example of a process for refurbishing aerostructures in accordance with the present disclosure. At 19000, a holding fixture is designed and constructed. At 19010, the fixture is digitally scanned in order to establish a “zero” plane or reference plane relative to (extending through the center of) the fixture. At 19020, the dimensions of the fixture and the special coordinates of the reference plan are stored into a computer processing unit (CPU). At 19030, a structure needing repair is installed into the fixture. At 19040, surface of the structure is digitally scanned to determine structure dimensions and rivet hole locations. At 19050, the dimensions and fastener locations are stored in the CPU. At 19060, the structure is inspected (e.g., by digital nondestructive inspection (NDI) or nondestructive testing (NDT)) to detect any surface fractures, deformation, or defects. At 19070, an EDrill is guided by photogrammetric software to remove the fasteners from the structure surface. At 19080, after fasteners are removed, the skin or other outer parts of the structure are removed. At 19090, (interior) substructure is digitally scanned to capture its dimensions and fastener locations. At 19100, the substructure is inspected (e.g., by digital nondestructive inspection (NDI) or nondestructive testing (NDT)) to detect any surface fractures, deformation, or defects. At 19110, repair or replacement of structure parts and/or components is done. At 19120, the structure is reassembled, beginning with re-drilling new fastener holes in the new or reconditioned skins and/or parts. At 19130, the EDrill is guided by photogrammetric software to install fasteners into the structure surface until the structure is reassembled.

Although the examples described herein are particularly suited for refurbishing aerostructures, the invention can be used for refurbishing any type of structure.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

What is claimed is:

1. A system for refurbishing an aerostructure, comprising:
a structure assembly comprising a holding fixture and a structure supported by the fixture;
an imaging device; and
an image projection apparatus,
wherein the imaging device and the image projection apparatus are electrically coupled to a central processing unit,
wherein the imaging device may include one or more digital cameras positioned at various locations about the structure assembly to capture images of the structure along various lines of sight, and
wherein the captured images are transmitted to the central processing unit where the images are stored as data and a three-dimensional surface model representing the external surfaces of the structure is generated by computer-aided design software executed by the central processing unit.

2. A method for refurbishing an aerostructure, comprising:
constructing a fixture for supporting the aerostructure;
scanning the fixture with digital cameras, the digital cameras being in electrical communication with a central processing unit which generates a three-dimensional surface model representing the external surfaces of the fixture and a simulated two-dimensional reference plane extending through the center of the fixture;
installing the aerostructure within the fixture, the aerostructure having a skin that encloses an interior substructure;
scanning the skin of the structure the digital cameras, wherein the central processing unit generates a three-dimensional surface model representing the external surfaces of the aerostructure;
removing fasteners securing the skin to the aerostructure, the fasteners being removed by an automated drill in electrical communication with the central processing unit;
removing the skin from the structure such that a substructure of the structure is exposed;
scanning the substructure with the digital cameras, wherein the central processing unit generates a three-dimensional surface model representing the external surfaces of the substructure;
providing a new skin, the new skins being scanned by the digital cameras, wherein the central processing unit generates a surface model depicting a three-dimensional replica of the new skins;
drilling new fastener holes into the new skin at locations corresponding to the fastener hole locations in the substructure; and
fastening the new skin onto the substructure.

3. A method for refurbishing a structure, comprising:
constructing a fixture for supporting the structure;
scanning the fixture with an imaging device, the imaging device being in electrical communication with a central processing unit which generates a three-dimensional surface model representing the external surfaces of the fixture and a simulated two-dimensional reference plane extending through the center of the fixture;
installing the structure within the fixture, the structure having outer surfaces;
scanning the outer surfaces of the structure with the imaging device to determine the peripheral dimensions of the structure and the location of fasteners coupled to the outer surfaces to structure, wherein the location of each fasteners is defined by a rivet hole and the central processing unit generates a surface model representing the three-dimensional dimensions of the aerostructure;
removing fasteners securing the outer surfaces to structure, the fasteners being removed by an automated drill in electrical communication with the central processing unit;
removing the skin from the structure such that a substructure of the structure is exposed;
scanning the substructure with the digital cameras, wherein the central processing unit generates a three-dimensional surface model representing the external surfaces of the substructure;
providing a new skin, the new skins being scanned by the digital cameras, wherein the central processing unit generates a three-dimensional surface model representing the surfaces of the new skins;
drilling new fastener holes into the new skin at locations on the new skin corresponding to the fastener locations in the replaced skin; and
fastening the new skin onto the substructure.
